(19) United States
(12) Patent Application Publication
(10) Pub. No.: US 2023/0314148 A1
(43) Pub. Date: Oct. 5, 2023

(54) ROUTES OPTIMIZATION SYSTEM BASED ON RAILROAD AND STREET TRAFFIC INFORMATION

(71) Applicant: University of South Carolina, Columbia, SC (US)

(72) Inventors: Yu Qian, Irmo, SC (US); Yuche Chen, Lexington, SC (US)

(73) Assignee: University of South Carolina, Columbia, SC (US)

(21) Appl. No.: 18/161,155

(22) Filed: Jan. 30, 2023

Related U.S. Application Data
(60) Provisional application No. 63/325,747, filed on Mar. 31, 2022.

(51) Int. Cl. G01C 21/34

(52) U.S. Cl. CPC G01C 21/3446; G01C 21/3461; G01C 21/3492

(57) ABSTRACT

Described herein are systems and methods for identifying an optimal travel route for first travelers, such as commuters, first responders, etc., that considers both potential railroad crossing blockages in addition to street traffic congestion conditions to provide real-time optimal vehicle routing based on real-time street and railroad crossing conditions.

### STATEMENT REGARDING FEDERALLY SPONSORED RESEARCH

This invention was made with government support under Federal Railroad Administration Grant 693JJ621C000015. The government has certain rights in this invention.

### TECHNICAL FIELD

The subject matter disclosed herein is generally directed to systems and methods for identifying an optimal travel route for first travelers, such as commuters, first responders, etc., that consider both potential railroad crossing blockages in addition to street traffic congestion conditions to provide real-time optimal vehicle routing based on real-time street and railroad crossing conditions.

### BACKGROUND

Current navigation systems, such as GOOGLE MAPS, APPLE, etc., calculate optimal routes based on street traffic information to calculate estimated travel and arrival times. However, this completely ignores railroad traffic information. If there is a railroad track blockage, loading delay, accident, etc., these incidents can all drastically vary travel times and estimations for reaching destinations.

Accordingly, it is an object of the present disclosure to develop a system that is able to identify the optimal route for the travelers, considering both potential railroad crossing blockage as well as dynamic street traffic congestion conditions. The system will integrate Positive Train Control (PTC) data, real-time communication, street traffic monitoring, and stochastic and robust optimization into a cloud computing platform.

Citation or identification of any document in this application is not an admission that such a document is available as prior art to the present disclosure.

### SUMMARY

The above objectives are accomplished according to the present disclosure by providing in one embodiment systems for identifying an optimal travel route for travelers, such as commuters, first responders, etc., that consider both potential railroad crossing blockages in addition to street traffic congestion conditions to provide real-time optimal vehicle routing based on real-time street and railroad crossing conditions.

In one embodiment, the disclosure provides a first responder shortest path optimization method. The method may include determining a time window at at least one location to be avoided by at least one vehicle, wherein the at least one vehicle may originate at multiple origin points and have only a single destination, wherein at least one shortest path algorithm may be dynamically updated during a time the at least one vehicle is traveling to the single destination to choose a shortest path to the single destination while avoiding the at least one location to be avoided; and wherein the shortest path optimization model can be generated with the following:

$$min {D}_{total} = {min}_{x} {\sum }_{( i , j ) ∈ A} {D}_{j} \cdot {x}_{i j}^{rs} , ∀ r , s ∈ V \qquad ( 12 )$$

$${\sum }_{j} {x}_{i j}^{rs} - {\sum }_{i} {x}_{i j}^{rs} = \{ \begin{matrix}1 , ∀ i = r \\ 0 , ∀ i \neq r , ∀ j = s \\ - 1 , ∀ j = s\end{matrix} \qquad ( 13 )$$

$${x}_{i j}^{rs} = \{ \begin{matrix}1 , if {a}_{ij} lies on the path ( r , s ) \\ 0 , otherwise\end{matrix} , ∀ {a}_{i j} ∈ A , ∀ r , s ∈ V \qquad ( 14 )$$

wherein
Dₜₒₜₐₗ is total delay time; and
xᵢⱼ^{rs} is a binary decision variable, wherein xᵢⱼ^{rs}=1 if the link aᵢⱼ lies on the path (r, s), otherwise, xᵢⱼ^{rs}=0.

Further, the at least one vehicle may be a first responder vehicle comprising an ambulance, firetruck, law enforcement vehicle, paramedic, and/or emergency medical technician and/or combinations of the above. Still yet, the at least one location to be avoided may a railroad crossing. Yet again, the method may comprise extracting GPS locations for the at least one location to be avoided. Again still, the method may designate each destination to be avoided as a node and paths to the single destination as arcs. Further still, the at least one location to avoided may be a railroad crossing wherein a train may be passing and the algorithm accounts for at least train length, current location, and operating speed with respect to the at least one locations to be avoided. Again yet further, objective function equation 12 may calculate and minimize total delay time, equation 13 may represent flow balance constraints for a path from an origin point to a destination point, and equation 14 may define a binary decision variable. 8. The method of claim 7, wherein the origin point is a fire station selected from amongst a group of fire stations with a firetruck dispatched from the fire station that is determined as meeting the shortest path optimization model to the destination.

In a further embodiment, the disclosure may provide a train blockage time window prediction method. The algorithm may calculate an expected delay time at a particular railroad crossing comprising:

$${D}_{v} = \{ \begin{matrix}0 , if {T}_{v} < {t}_{v}^{0} or {T}_{v} > {t}_{v}^{1} \\ {t}_{v}^{1} - {T}_{v} , Otherwise\end{matrix} \qquad ( 7 )$$

With the expected delay time calculated as:

Dₜₒₜₐₗ=Σ_{v∈V}Dᵥ (8)
Wherein Dᵥ is expected time delay at the particular railroad crossing;
Dₜₒₜₐₗ is total delay time;
Tᵥ is accumulative time after an emergency occurs when an emergency vehicle arrives at the particular railroad crossing; and
[tᵥ⁰, tᵥ¹] is a train blockage window at point v starting at t=tᵥ⁰ and ending at t=tᵥ¹.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows an overview of proposed modules of the proposed system of the current disclosure.

FIG. 2 shows an illustration of one embodiment of a current and potential future crossings blockages update based on actual train path and check points of the current disclosure.

FIG. 3 shows an illustration of an integration of street traffic, railroad crossing blockage, and a first responder's location for optimal routing per the current disclosure at: (A) an optimal path when no railroad crossing blockage is present; and (B) an optimal path when a railroad crossing blockage is present.

FIG. 4 shows at: (a) an illustration of dynamic traffic information of Columbia, SC for optimal route selection; and (b) a real-time traffic condition overlay.

FIG. 5 shows a graph of development progression of the current disclosure.

FIG. 6 shows Table 1—Potential Data Sources, Formats and Frequencies.

FIG. 7 shows TABLE 2 Network Scale Comparison.

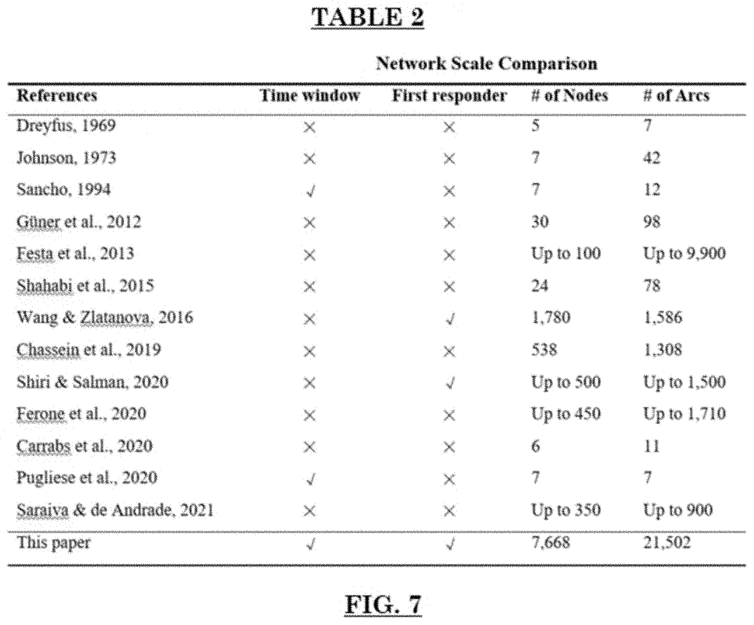

FIG. 8 shows at (a) Pattern I; (b) Pattern II; (c) Pattern III; (d) Pattern IV; Pattern V; and Pattern VI, Major Patterns of CSX Freight Train Routes in Columbia, SC (1:242,000 shown in ArcGIS Pro).

FIG. 9 shows TABLE 3, the instantaneous velocity distribution of 33,617 trains from the GPS data within 20 km of the City of Columbia center

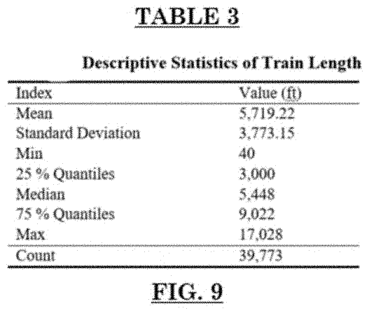

FIG. 10 shows Instantaneous Train Speed Distribution from GPS Data.

FIG. 11 shows the road network of the City of Columbia, SC.

FIG. 12 shows TABLE 4, variables and definitions.

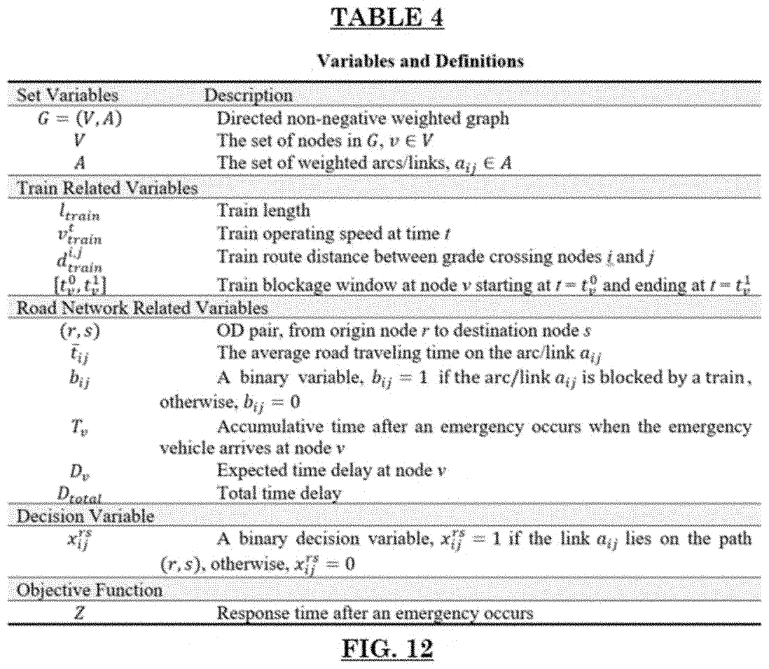

FIG. 13 shows a flowchart of the modified label correcting algorithm of the current disclosure.

FIG. 14 shows the locations of fire department stations and destination locations.

FIG. 15 shows TABLE 5, train blockage windows at grade crossings.

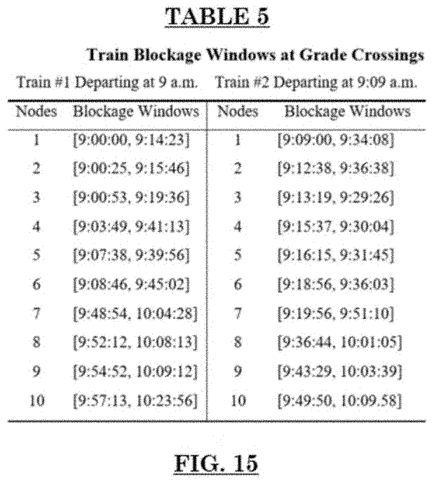

FIG. 16 shows TABLE 6, shortest path distance from each fire station to the destination location.

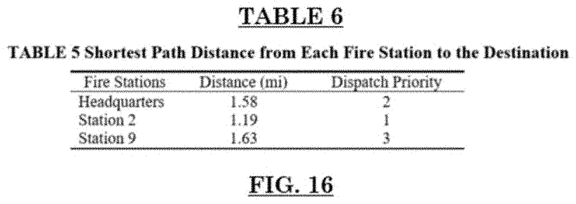

FIG. 17 shows at (a) baseline calculation and (b) minimum response time route of a comparison of time-based shortest path and baseline at 8:50 a.m.

FIG. 18 shows at (a) baseline calculation and (b) minimum response time route at 9:07 a.m.

FIG. 19 shows at (a) baseline calculation and (b) minimum response time route at 9:10 a.m.

FIG. 20 shows TABLE 7, summary of emergency vehicle dispatch and shortest path choosing strategies.

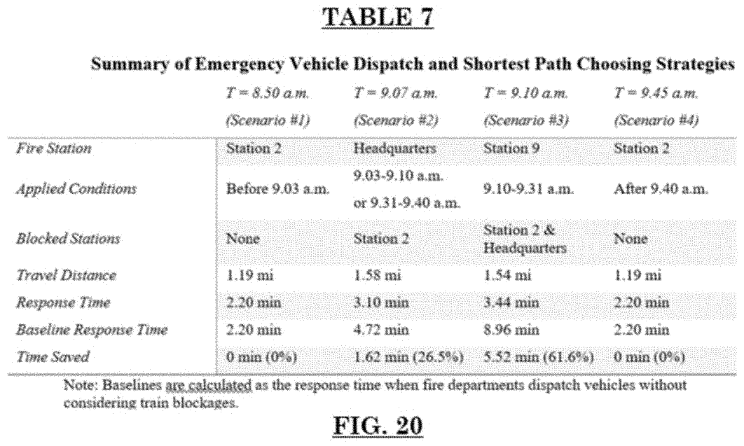

FIG. 21 shows a map of first responding units and their serving areas.

FIG. 22 shows at (a) node 7477, (b) node 7507, (c) node 4708, and (d) node 7511 of a comparison of time-based shortest paths for first responder units (t=9.00 a.m.).

FIG. 23 shows at (a) node 7507 and (b) node 4443 of a baseline calculation or first responder units (t=9.10 a.m.).

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the systems and methods described herein can be presented as a combination kit. As used herein, the terms “combination kit” or “kit of parts” refers to the methods, systems, analytical systems, route optimization components, etc., and any additional components that are used to package, sell, market, deliver, and/or provide the systems and methods described herein. Such additional components include, but are not limited to packaging, directions, hardware, software, and the like. When one or more of the methods or systems described herein or a combination thereof (e.g., a software system provided with a hardware system provided simultaneously, the combination kit can contain the systems or methods in a single combination, such as an application to be downloaded to a smartphone, or in separate combinations, such as software and a separate hardware device for displaying the optimal routes provided herein. When the systems and methods described herein or a combination thereof and/or kit components are not provided simultaneously, the combination kit can contain each component in separate combinations. The separate kit components can be contained in a single package or in separate packages within the kit.

In some embodiments, the combination kit also includes instructions printed on or otherwise contained in a tangible medium of expression. The instructions can provide information regarding the systems and methods, data provided from same, safety information, directions for use, and/or recommended uses for the systems and methods disclosed herein. In some embodiments, the instructions can provide directions and protocols for using the systems and methods described herein.

Current navigation systems, such as GOOGLE MAPS, APPLE, etc., calculate optimal routes based on street traffic information. But still, the travelers would need to spend more time if there are any railroad crossing blockages. The current practice cannot consider the delay due to the railroad-highway crossing blockage. It is always puzzling to travelers and navigation systems if they should wait or find an alternative route to their destination. The situation quickly escalates in concern if first responders are caught in the waiting queue, especially if they are in response to an emergency. The system of the current disclosure considers both street traffic information and potential railroad crossing blockages. The current disclosure can identify the best route option to let travelers know if it is better to wait in case of a potential crossing blockage or identify another route. For first responders, we can provide assistance to the dispatching center as to which unit should be deployed and follow which specific route by considering both street traffic conditions and the potential crossing blockages due incoming trains.

The objective of the current disclosure is to develop a practical system that is able to identify the optimal route for the first responders in case of emergency, considering both potential railroad crossing blockage and dynamic street traffic congestion conditions. The system will integrate PTC data, real-time communication, street traffic monitoring, and stochastic and robust optimization into a cloud computing platform. The success of this research will leverage utility and value of PTC data to benefit first responders, especially in case of emergency. This project will also introduce railroads into the grand smart transportation system and bring positive impact to the local community, local, state, and federal administration and legislation.

Vehicles have to yield to trains approaching or passing the grade crossings until the crossing is cleared. The entire waiting/delay time depends on the train operation and the traffic flow. In North American, trains typically have 100 cars or more, and the delay time can easily take 5-10 minutes or more. Unfortunately, railroads do not share their operating information with the public, and currently there is no navigation apps in the market for delay assessment at railroad crossing or optimal traffic rerouting. Both factors cause severe traffic jams at grade crossings, especially in highly populated areas. Even worse, trains can move at extremely slow speed or fully stop at crossings, leading to lengthy traffic blockage and traffic congestion. There are many circumstances where the train blockage can occur more than 100 times daily, e.g., at Morehead, Minnesota (Arick 2015) or cost more than 45 minutes during peak hours, e.g., in downtown Portland, Oregon, giving rise to huge traffic jams and delay to work, school, etc. (Njus 2016).

In addition to the delay and traffic congestion, the most serious consequence of grade crossing blockage is the hindrance to First Responders in case of emergency. They have to wait until the trains and blocked traffic are completely cleared, which can take anywhere from minutes to an hour, possibly longer, and potentially cause unaffordable losses to life, properties, and assets. In 2015, Sarah E. Feinberg, former Administration of the FRA, acknowledged in a speech that “blocked crossings are among the top complaints the FRA received” (Njus 2016). First responders, including fire fighters, police, and ambulances, are all impacted by the blocked traffic at crossings. The fire fighters at Morehead, Minnesota could only make their response time goals 2 out of 10 times and their routes are blocked up to 6 hours a day (Arick 2015). They were stuck at a railroad crossing 118 times during 2014 while responding to emergency calls (Welker 2015). Police Chief Mark Veirg at Cokeville, Wyoming, reported the train sometimes sat at the crossing for hours, rendering it difficult for them to make a decision between waiting and taking an alternative route, and the latter is 44 miles longer (kutv.com/news/get-gephardt/trains). EMT Reane Tichert once had to throw medical supplies from the ambulance over a parked train down to another EMT on an ATV to reach a baby that was struggling to breathe, due to the blocked crossing by a stopped train (kutv.com/news/get-gephardt/trains). The city of Circleville, Ohio has 18 railroad crossings (including 10 mainline railways) in less than 7 square miles. The fire chief at Circleville confirmed that he has had units stranded by the train that were forced to watch the site of the fire they were sent to fight burn down (Namigadde 2017).

The current disclosure seeks to provide an Intelligent Crossing Assessment and Traffic Sharing System (i-CATSS) which will provide motorists, especially first responders, with real-time quantitative traffic information and estimated delay/waiting times at grade crossings. i-CATSS features salient wireless communication, computer vision, AI and data analytics, and in-situ information sharing on an embedded and autonomous “cyber-physical systems/CPS” platforms installed at grade crossings. The current scope of i-CATSS will calculate the expected crossing delay time for the first responders and pass that information to the dispatching center.

Based on conversations with the dispatching center at the City of Columbia, SC, they will use the calculated delay time as a reference to help them to decide which unit to be dispatched based on their experience and best judgement. However, it would still be challenging for them to make a decision because the crossing information is not integrated with the route calculation system. In other words, the dispatching center will need to rely on their experience to make a judgement by considering the route calculated based on the street traffic only and potential crossing information separately. It will be more efficient if any program or software can directly utilize the railroad crossing information and street traffic information together to make certain recommendations of the optimal route to assist the dispatcher to make a decision while they can also consider other factors to make the final selection. Thus, we propose to develop a practical system that is able to identify the best route for the first responders in case of emergency, considering both potential railroad crossing blockage and street traffic congestion conditions.

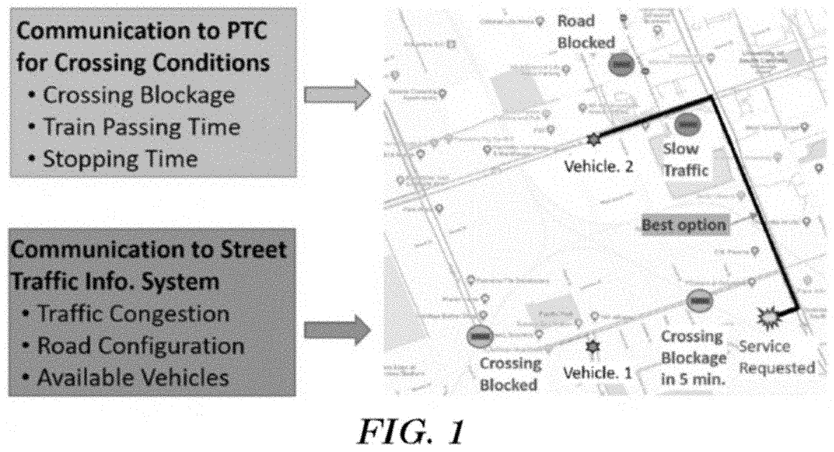

The success of the proposed system relies on the information/data from two sources: 1) the estimated time of any potential crossing blockage, based on the PTC data; and 2) the estimated travel time of the first responders, based on the street configuration and locations of available first responders. Based on the information from both the railroad and the city department of transportation, a best candidate vehicle will be recommended together with the optimal route from the candidate vehicle to the destination of the service. The proposed system will dynamically adjust itself to the most recent railroad crossing conditions, street traffic conditions, available vehicles and locations, and locations of service requested, to enhance accuracy and reliability of the optimized routes. FIG. 1 illustrates the systematic organization of the proposed system. The current disclosure may comprise four key modules: Module I: Communication with PTC System; Module II: Communication with Street Traffic Information System; and Module III: Real-time Optimal Vehicle Routing. The details of each individual module are presented in FIG. 1.

The proposed system will be developed by leveraging extensive R&D experience of the research team on railroad infrastructure, communication, and traffic operation. The proposed innovation is based on several key branches, including: cloud computing, PTC data or other train dispatching data sharing, real-time communication, street traffic monitoring, and stochastic/robust programming.

The current disclosure provides a practical system that is able to identify the optimal route for first responders in case of emergency, considering both potential railroad crossing blockage and street traffic congestion conditions will be developed. The developed system will leverage utility and value of PTC or alternative forms of train operation data to benefit the first responders to select the optimal route to save critical time, especially in case on emergency. This disclosure will also introduce the railroad into the grand smart transportation system and bring positive impact to the local community, local, state, and federal administration, and legislation. It will significantly help the local dispatching center to made effective decisions and improve quality of life.

The current disclosure includes three work packages and an optional package. The first task (Work Package 1) is Sequential Crossings Blockage Prediction. Based on the foundation of previous research efforts to establish the communication channel between on board PTC and our device for a particular crossing, this task aims to expand the prediction into multiple crossings along the track. Based on the train operation speed, GPS locations, etc. informed by the on board PTC system or other signaling and control unit, the estimated blockage time for all the crossings within the interested area along the train's path will be calculated together with the distance between one crossing to the following crossing. The anticipated blockage starting time, blockage duration, and blockage ending time will be reported for each crossing.

The second task (Work Package 2) is Street Traffic Information Integration. Depending on the data refreshing rate and time, street traffic information from publicly available applications (i.e., GOOGLE Maps) or from the department of transportation of the local government will be integrated and analyzed to reflect the most recent street traffic conditions. The available vehicles numbers and their real-time locations will be provided by the dispatching center and included into the system together. This task aims to include all the street traffic information and available responders to establish the real-time traffic constrains before calculating the optimal route options when a service request is received.

The third objective (Work Package 3) is Dynamic Optimal Vehicle Routing. The vehicle routing will utilize stochastic sequential crossing blockage prediction and dynamic street traffic information to search for optimal routing, in a real-time manner. The project team will establish the conceptual mathematical formulation first and then explore traditional algorithm and advanced asymptotical algorithms (such as Dijkstra's algorithm with Fibonacci heap), which have been proven to be able to solve the route searching problem in a short timeframe (second-level) in a road network comparable or larger than Columbia, SC.

The fourth objective (Work Package 4) is to conduct a Field System Testing. Upon the completion of the tasks above, the research team will test the developed system with the first responders of the City of Columbia, SC, based on the availability and schedule of both CSX and the City of Columbia. The recommended route considering both railroad crossing blockage information and street traffic information will be compared with the route that selected by the dispatcher based on experience only. Note due to COVID-19, CSX does not run PTC equipment trains through Columbia, SC. However, the same information needed for the proposed work can be also obtained from CSX′ dispatching system.

Work Package 1—Sequential Crossings Blockage Prediction

Work package overview: In urban areas, trains will cross many streets along the track, causing street traffic delays different locations. Depending on the track distance between crossings, different crossing along the same track would be blocked in a sequential order at different time. Based on the train operation speed, GPS locations, and track length, etc., the estimated blockage time for all the crossings within the interested area along the train's path can be calculated. This work package will focus on identifying the major crossings that would block major streets due to a passing train within the interested area. The estimated arrival time will be calculated and sorted based on specific train information that shared by the on-board PTC system or alternative system that having the train GPS location and speed information.

Work Package 2—Street Traffic Information Integration

Work package overview: This package will focus on obtaining the street traffic information of the area of interest to assessing the current street traffic conditions, including traffic lights, road maintenance activities, temporary closed road, and traffic congestions. Depending on the data refreshing rate and time, street traffic information from publicly available application (i.e., GOOGLE Maps) or from the department of transportation of the local government will be obtained, distilled, and analyzed to reflect the most recent street traffic conditions. The available first responders' vehicles and their real-time locations will be provided by the dispatching center and included into the system together. This work package aims to include all the street traffic information, available first responders, and the crossing blockage information to establish the real-time traffic constrains before calculating the optimal route options when a service request is received.

Work Package 3—Dynamic Optimal Vehicle Routing

Work package overview: With the street traffic information, available first responders, and potential crossing blockages integrated from Work Package 2, this work package aims to identify the best vehicle for a service request and provide the optimal route in response to an emergence situation. The vehicle selection and the recommended routing will utilize stochastic sequential crossing blockage prediction and dynamic street traffic information to search for the optimal strategy, in a real-time manner.

Work Package 4—Field System Testing

Work package overview: In this work package, the research team will test the developed system with the first responders of the City of Columbia, SC. The recommended route considering both railroad crossing blockage information and street traffic information will be compared with the route that selected by the dispatcher based on experience only to quantify potential benefits in terms of reaching the location of emergency.

The current disclosure includes four key modules: Module I: Sequential Crossings Blockage Prediction; Module II: Street Traffic Information Integration; and Module III: Dynamic Optimal Vehicle Routing; and Module IV: Field System Testing. The details of each module are introduced in detail below:

Module I. Sequential Crossings Blockage Prediction:

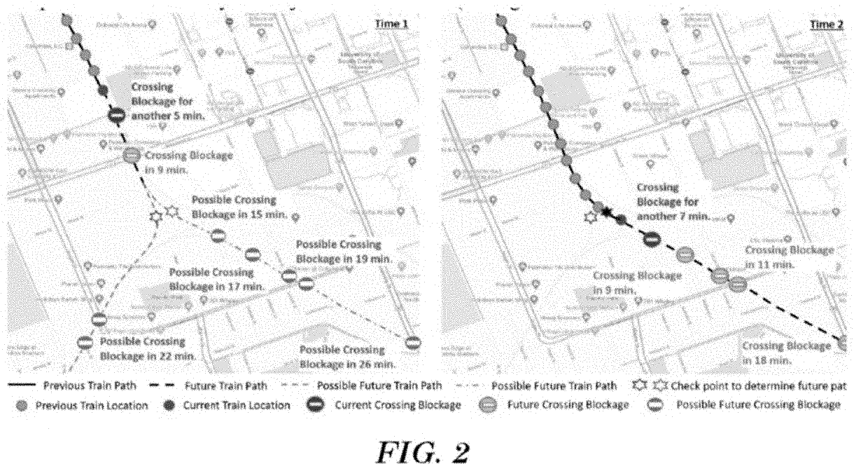

This objective of this module is to develop the capability to predict multiple crossings' blockage time along the same track in a sequential order. Based on the foundation the previous research effort to establish the communication channel between on board PTC and our device for a particular crossing, the research team has developed a program to predict the estimate blockage time for one selected crossing with the train operation information, including GPS location and the operation speed. The estimated arrival time is calculated based on the track distance between the crossing of interest and the current train location and speed. This module will expand the current developed program to predict sequential crossings' blockage time(s). The estimated arrival time of the running train to different crossings will be calculated by the track distance between the current train location to the different crossings. The main challenge in this module is the running train does not have a defined path. Although the train has a destination, the exact route remains unknown. In other words, the same train could take different tracks and go through different crossings to arrive at the same destination. Based on the experience of the research team, and the conversation between the research team and the industry partner, CSX, there is no exactly defined route for a particular train. It is the dispatcher who direct the train to different tracks based on the specific track occupancy condition along the route. The PTC system will be updated every time after the dispatcher send the orders. Thus, the routing information distilled from PTC system would also be dynamically updated. In terms of sequential crossings' blockage prediction, all the crossings along the possible route selections between the current train position and the destiny are subjected to be blocked (see FIG. 2 for illustration).

As shown in FIG. 2. As the train is approaching urban areas, there are multiple possible future train path. Thus, the proposed system will need to identify all the potential crossing blockages along all the possible train path and calculate the corresponding estimated arrival time. As the train information shared by the railroads from either PTC or other dispatching program keeps feeding into the program, the program will check if the train has passed certain check point to determine the actual future train path. Once the actual future train path has been identified, estimated blockage time will be calculated only for crossings along the actual train pass and reported in a sequential order from earliest to the latest. While, the crossings along other paths will be reported as cleared. This module will dynamically update the future possible crossing blockage and future crossing blockage in time based on the information shared by the railroads.

Module II. Street Traffic Information Integration:

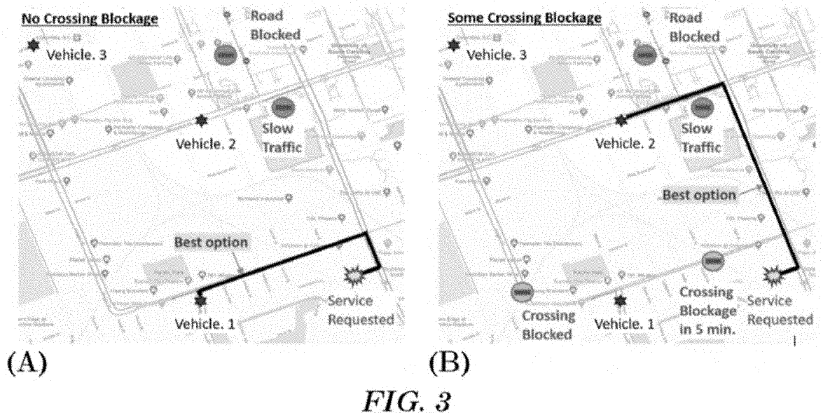

This module primarily aims to integrate the traffic condition within the interested territory, i.e. city limit, into the proposed system by communicating with the street traffic information program, which is typically managed by the department of transportation of the local government. The street traffic information system actively monitors the street traffic conditions, such as normal or heavy traffic, road blockage due to accidents or special events, traffic detour due to maintenance activities. These types of street information can also be obtained based on publicly available applications, such as GOOGLE Maps, or APPLE Map, but information directly shared by the local government will be more accountable and in time. The communication from the street traffic information system to the proposed system will also be secured through a one-way channel to prevent malicious attacks. Note an active project sponsored by FRA as mentioned earlier has been developing the communication channel to pass crossing blockage information to the 911 dispatching center. This project will use the same channel to receive the street traffic information from the department of traffic of the local government and process the data in real-time in order to calculate the optimal route options whenever needed. Depending on the information that the local government would like to share, this system can integrate location information of the candidate first responder vehicles selected and shared by the dispatching center when an emergency happened. Alternatively, the proposed system would be developed to integrate and synchronize the available candidate first responder vehicles at the refreshing rate (e.g., every 5 to 10 minutes) set by the dispatching center. The first responder vehicles location information will be processed in a similar way of the train information. The optimal route will be calculated based on the traffic condition, including the current and potential crossing blockage, and the real position of the available first responders. FIG. 3 provides an example to illustrate the importance of the information integrated into the proposed system.

After a recommended optimal route and the corresponding candidate first responder vehicle/unit is identified, the candidate vehicle along with the selected route will be shared back with the dispatching center through a cloud computing platform that the dispatching center preferred. Note the final dispatching decision will still be made by the dispatching center, the proposed system aims to provide potential options to ease the burden of the dispatcher and assist making more effective decisions.

Module III. Dynamic Optimal Vehicle Routing

This module aims to establish a data-driven dynamic vehicle routing optimization algorithm that determines candidate first responder vehicle and associated optimal route to the destination of service requests under uncertain railroad crossing information. This module will communicate, in a real-time manner, with a cloud-based computing platform to fetch dynamic (e.g., traffic congestion) and static (e.g., road type, speed limit) street traffic information to match service request with the first responder vehicle and determine the optimal route with the minimum trip time. Note the algorithm will not only utilize dynamic traffic information, but also consider stochastic traffic incidents (e.g. accident and road blockage) on road network based on data mining of real-time and historical traffic monitoring data. Thus, the recommended optimal route can be as robust as possible for the selected first responder vehicle to reach the designated destination within the planned travel time.

The solution algorithm for the dynamic optimal (shortest path or minimum travel time) vehicle routing problem is based on graph theory. Mathematically, given a directed graph (V, A) with V stands for the set of all nodes and A stands for the set of all edges. Let wᵢⱼ stand for travel time/cost between each pair of edge (i,j) in edge set A. It can be defined that binary variable xᵢⱼ, equal to 1 when edge (i,j) is part of the shortest path, and equal 0 otherwise. Therefore, the formulation for a static shortest path problem for one pair of origin and destination (s, t) is given as following:

$$min f ( x ) = {\sum }_{i , j ∈ A} {w}_{ij} * {x}_{ij} \qquad ( 1 )$$

$${\sum }_{j} ( {x}_{ij} - {x}_{ji} ) = \{ \begin{matrix}1 & i = s \\ - 1 & i = t \\ 0 & else\end{matrix} \qquad ( 2 )$$

$${x}_{ij} ∈ \{ 0 , 1 \} \qquad ( 3 )$$

Because the traffic information changes dynamically based on vehicle flow traveled on roads of the transportation network, the shortest path formulation will incorporate dynamic traffic information on travel time on each of road edge (i, j). Therefore, in equation (1), wᵢⱼ(t) will be associated with travel time t, which means link travel time will be re-evaluate at the time when first respond service is requested at t. Real-time link travel time at t can be obtained from traffic data monitoring site, such as GOOGLE Maps API. But travel time on links with current and possible crossing blockage should be modified to construct a robust and risk-averse first response route choice. Specifically, travel time of road links undergoing train crossing will be infinitely large (∞) so that they will not be selected in the route to prevent delay for first responder services. Depending on first responders' practice, the project team will develop different procedures to consider road links with possible train crossing blockage in determining the optimal route. One option is to exclude all links with possible train crossing. This is the most conservative way in route planning but could lead to limited routing option and longer response time. Another option is to include links with possible crossing if the estimated train arrival time is significant large than average response time based on first responders' experience. For example, if average first response time is 10 minutes, then links with estimated train arrival time greater than 20 minutes can be considered in route planning. No matter how is travel time on links with possible train crossing determined, it is important to ensure the decision is robust under any kind of extreme situation. This means that the proposed vehicle routing algorithm will eliminate any chance that the first responder vehicle will be stopped at a railroad crossing to wait until the train is cleared.

The computational time for finding the optimal route will increase quadratically with the total number of edges in a road network. The project team will explore traditional algorithm and advanced asymptotical algorithms (such as Dijkstra's algorithm with Fibonacci heap), which have been proven to be able to solve in a short timeframe (second-level) in a road network comparable or larger than the City of Columbia, SC.

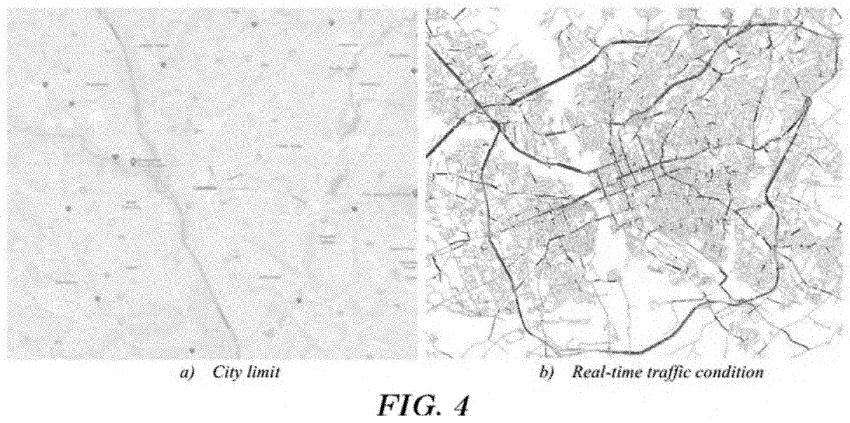

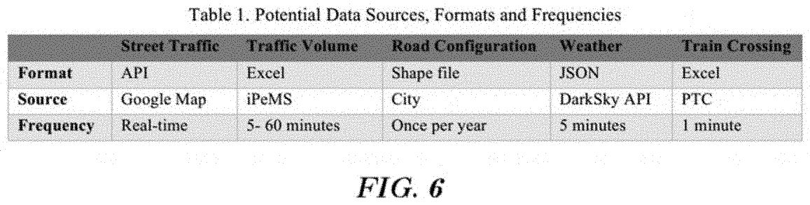

FIG. 4 presents an illustration of dynamic traffic information with real-time travel time and traffic congestion information in Columbia, South Carolina that will be used to determine optimal routes. Table 1, see FIG. 6, presents a list of potential data sources, format and frequency that can be used in this project. The real-time traffic will be collected by dynamically searching GOOGLE Maps using API. The project team will also explore other traffic data maintained by local transportation authorities. The local weather data can be connected from real-time weather data provider, such as Dark Sky API.

Module IV. Field Testing: Upon the completion of the tasks above, the research team will take a field testing of developed program. Based on the availability and schedule of both CSX and the City of Columbia. A mock emergency request will be sent to the first responders dispatching center. The dispatcher will select an available unit solely based on the current practice without any assistance from the proposed system. The program will generate its own recommended route with the corresponding available unit based on both the street traffic information and the crossing blockage information. The arrival time from different units will be compared to test the benefit of the proposed system.

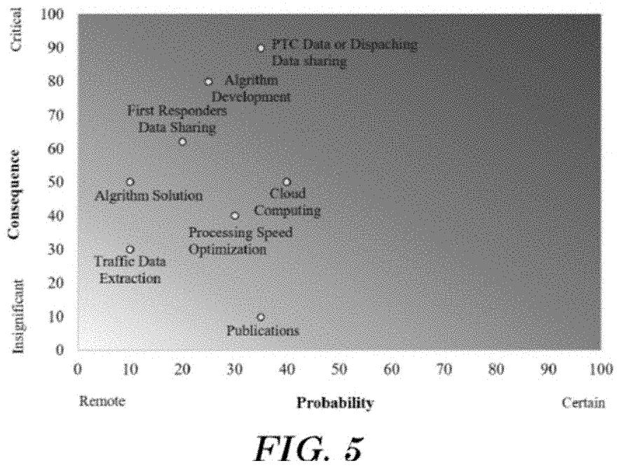

The risk of the proposed development is low while the benefit for advancing track risk management is exceedingly high. A risk assessment is shown in the FIG. 5.

Major areas of risk (and mitigation plans) include the following:
Challenges in PTC data sharing from the railroad partner. The train operation data, including the approaching train location and speed are the foundation of the proposed system. (potential solution: The train information supposed to be shared from PTC can also be shared directly from the railroad's dispatching system. In fact, based on the conversation with the industry partner, the dispatcher dynamically determines the train path based on the actual occupancy of the track and the destination of the train. The routing information in the PTC system will be updated once a new order is sent from the dispatcher. Although the industry partner, CSX, has rerouted the PTC-enabled trains away from Columbia area, the information needed for the proposed system could be directed shared by their dispatching center.

The current disclosure leverages utility and value of PTC data to benefit the local community and develop positive social impact. It also assess sequential crossings conditions along the train route. Previous project has developed information sharing channels with the first responders, this proposed work will further integrate the information into the preferred dispatching mapping platform. Integrate railroad into grand smart transportation management system.

The current disclosure analyzed the train GPS data from the City of Columbia, South Carolina, identified six major train route patterns and investigated the train blockage influence on road traffic, especially for the first responders. The current disclosure provides a train blockage time window prediction method, which can estimate train arrival and duration time at each grade crossing node. Based on the train blockage time window information, the team also developed a first responder shortest path planning optimization model to minimize the total response time. Several case studies have been conducted in Columbia, SC, which show the proposed algorithm can help save up to 61.6% response time for fixed fire station dispatching scenarios and 55.3% for stochastic unit dispatching, compared to those before optimizing, i.e., the baseline response time.

The current disclosure also provides an innovative Intelligent Crossing Assessment and Traffic Sharing System (i-CATSS) that can detect and predict highway-rail blockages at grade crossings and provide first responders with real-time information of traffic conditions at crossings. The system evaluates the total expected delay time due to both passing trains and vehicle congestion in front of the railroad crossing.

The disclosure has also developed a graphic user interface to display the estimated arrival time of the train and the estimated departure time for the monitored crossing, given the information shared from the partner railroad. Traffic status is consistently updated when new incoming information is received.

The current disclosure also provides an artificial intelligence (AI) model to detect the number of vehicles waiting in front of the blocked crossing. The system automatically starts whenever a train is detected within the area of interest by a surveillance camera. The correlations between the number of the waiting vehicles and the delay time are established based on the AI model. The model training and validation are performed using the surveillance videos recorded at the crossing of interest.

First responders from Columbia, South Carolina, offered opinions on the impact of the unexpected railroad blockages through a survey. They also assisted in system development. The Department of Transportation of the City of Columbia assisted in location identification and video collection. Industry partner CSX provided the train operation information for system development and improvement.

Background and Literature Review

In 2019, the Columbia-Richland Fire & Rescue responded to nearly 32,000 calls—an average of more than 2,600 calls per month. Of that amount, 53 percent were related to Emergency Medical Services (EMS), motor vehicle accidents, or rescue, and six percent were fire related calls, i.e. 1,920 fire related emergencies. The term “first responders” refers to a range of professional occupations, including police officers, fire fighters, search and rescue personnel, ambulance personnel, and military personnel, see, Arble, E., Daugherty, A. M., & Arnetz, B. B. (2018). Models of first responder coping: Police officers as a unique population. Stress and Health, 34(5), 612-621. doi.org/10.1002/smi.2821, and the major goals of first responder vehicles is to save lives, reduce the injuries and limit damages on properties, see Jafari, M., Bakhadyrov, I., Maher, A., & Rutgers University. Center for Advanced Infrastructure & Transportation. (2003). Technological advances in evacuation planning and emergency management: Current state of the art. (EVAC-RU4474). rosap.ntl.bts.gov/view/dot/18368, and researchers have recognized that a repaid first response is associated with a higher survival rate. See, Bürger *, A., Wnent *, J., Bohn, A., Jantzen, T., Brenner, S., Lefering, R., Seewald, S., Gräsner, J.-T., & Fischer, M. (2018). The Effect of Ambulance Response Time on Survival Following Out-of-Hospital Cardiac Arrest. Deutsches Ärzteblatt International, 115(33-34), 541-548. doi.org/10.3238/arzteb1.2018.0541. To achieve this goal, the National Fire Protection Association (NFPA) Standard 1710 establishes an 80-second (for 90% of alarms received and processed) or 146-second (for 95% of alarms received and processed) “turnout time”, and 240 second “travel time” benchmark time goal for not less than 90% of dispatched incidents for fire and EMS response time. As a result, to save time on traveling, the decision-making of first responders on route determination requires accurate information on present and future traffic network. For urban areas that have railway routes, it is important to plan first responders' routing with consideration of potential delays due to the grade crossing blockage from a train passing.

A grade crossing refers to the location where a railway and a road cross at the same level. For a protected grade crossing, gate arms will block the road from an approaching train is detected until the train leave that track segment. Depending on the train length and train travel speed, the grade crossing blockage time varies a lot, ranging from a couple of seconds in case of only a locomotive quickly passing by to several hours in case of a stopped train at the grade crossing. During the crossing blockage, it is impossible and illegal for any vehicle or person pass through the blocked track. The unexpected delay at the grade crossing often challenges the first responders while they are counting on every second on the way to save lives and protect the communities.

In addition to the delay and traffic congestion, the most serious consequence of grade crossing blockage is the hindrance to the first responders responding to emergencies. They have to wait until the trains and blocked traffic are completely cleared, which can take anywhere from minutes to one hour and potentially cause unaffordable losses to lives, properties, and assets. In 2015, the former Administration of the Federal Railroad Administration (FRA) acknowledged that blocked crossings were taking the first place of complaints that the FRA received. See, Oregonian/OregonLive, E. N.|T. (2016, November 3). How long can trains block railroad crossings? (Commuting Q&A). Oregonlive. oregonlive.com/commuting/2016/11/how_long_can_trains_block_rail.html. The travel delay caused by highway-railway grade crossings may account for this phenomenon, especially in North America. See, Park, P. Y., Jung, W. R., Yeboah, G., Rempel, G., Paulsen, D., & Rumpel, D. (2016). First responders' response area and response time analysis with/without grade crossing monitoring system. Fire Safety Journal, 79, 100-110. doi.org/10.1016/j.firesaf.2015.11.003. Even for first responders, they can also be impacted by the blocked traffic at crossings. For example, Police Chief Mark Veirg in Cokeville, Wyoming, reported the train sometimes sat at the crossing for hours, rendering it difficult for them to make a decision between waiting and taking a 44-mile detour to turn around. See, Poe, M. G. and M. (2018, March 8). Trains blocking roadway creates dangerous situations, first responders say. KUTV. kutv.com/news/get-gephardt/trains. With the conflicts of trains and road traffics becoming more and more serious, many governments or transportation departments are trying to address the problem. The State of Utah makes “five consecutive minutes” an obligatory rule that a train cannot block the traffic more than five minutes. See, Id. Early in 2015, the city of Circleville, Ohio seriously considered cutting off 25% of the crossings (totally 18 crossings amongst the city) for safety concerns and to ease traffic congestion in this area. See, Circleville To Cut Number Of Railroad Crossings To Improve Safety. (2015, April 5). 10tv.Com. 10tv.com/article/news/circleville-cut-number-railroad-crossings-improve-safety/530-d5df0984-2d10-4e79-ab71-4c8689bb978a. Unfortunately, there is no system available to share the real-time grade crossing traffic condition and provide situational assessment information with first responders and the other involved parties, which raises significant safety concerns.

The current disclosure seeks to integrate both potential railroad crossing blockage information and dynamic street traffic congestion conditions to identify the optimal route for the first responders in case of emergency. The railroad crossing blockage information is obtained based on historical train operating data. The algorithm will determine the optimal routing that minimizes travel time. The algorithm will treat railway crossing period as time windows when solving the shortest path problem. The developed algorithm is solved, and applied, with respect to the City of Columbia, SC. The developed algorithm may assist the first responders to find the best route having the shortest respond time in case of emergency.

There are studies in literature that discuss navigation problems of first responders. Zlatanova et al. developed a database management system that contains information related to emergency services. See, Zlatanova, S., Kamal, S., & Baharin, K. (2008). Optimal Navigation of First Responders Using DBMS. 3rd International Conference on Information Systems for Crisis Response and Management 4th International Symposium on GeoInformation for Disaster Management. By performing various query selections, the system can combine information on emergency service vehicle locations and nature of the emergency to identify suitable vehicles to dispatch and then give vehicles autonomy in route selection. Rodriguez implement a Mento-Carlo framework to simulate through all possible routes to determine the route with minimum travel time and energy consumption. See, Rodriguez, A. (2019). Energy Consumption and Routing Model for First Responder Vehicles. The Pegasus Review: UCF Undergraduate Research Journal, 10(1). stars.library.ucfedu/urj/vol10/iss1/1 Above studies primarily rely on drivers' experience or enumerating all alternatives when determining routes for first responder vehicles.

Wang et al. developed a system that use historical spatial information, real-time meteorological data and a hazard simulation model to predict the occurrence of natural disasters. See, Wang, Z., & Zlatanova, S. (2016). Multi-agent based path planning for first responders among moving obstacles. Computers, Environment and Urban Systems, 56, 48-58. doi.org/10.1016/j.compenvurbsys.2015.11.001. Then, the system can notify first responder vehicle drivers about potential natural disasters for them to avoid in routing planning. Shiri and Salman studied the online multi-agent Canadian traveler problem, i.e., finding at least one feasible route from the origin to the destination within a minimum response time, then they proposed a corresponding effective online heuristic policy and tested the strategy on both real and generated networks. See, Shiri, D., & Salman, F. S. (2020). Online optimization of first-responder routes in disaster response logistics. IBM Journal of Research and Development, 64(1/2), 13:1-13:9. doi.org/10.1147/JRD.2019.2947002. And recently, machine learning or artificial intelligence are also applied to first responder vehicle navigations. See, Brown, A., & Taylor, B. D. (2018). Bridging the Gap between Mobility Haves and Have-Nots. In D. Sperling (Ed.), Three Revolutions: Steering Automated, Shared, and Electric Vehicles to a Better Future (pp. 131-150). Island Press/Center for Resource Economics. doi.org/10.5822/978-1-61091-906-7_6. Most of the above studies use either heuristic-based solutions in finding optimal routing for first responding vehicles.

There are studies that use closed-form shortest path algorithms to find the optimal routing for first responding vehicles. The shortest path problem has been widely studied since the 1960s in passenger car vehicle routing problems. See, Dreyfus, S. E. (1969). An Appraisal of Some Shortest-Path Algorithms. Operations Research, 17(3), 395-412. doi.org/10.1287/opre.17.3.395. The initial shortest path problems focus on the travel distance and have been successfully addressed with typical route planning algorithms, like Dijkstra's algorithm, see Dijkstra, E. W. (1959). A note on two problems in connexion with graphs. Numerische Mathematik, 269-271, label setting approach, see Dreyfus, S. E. (1969). An Appraisal of Some Shortest-Path Algorithms. Operations Research, 17(3), 395-412. doi.org/10.1287/opre.17.3.395, and Bellman-Ford algorithm. See, Awerbuch, B., Bar-Noy, A., & Gopal, M. (1994). Approximate distributed Bellman-Ford algorithms. IEEE Transactions on Communications, 42(8), 2515-2517. doi.org/10.1109/26.310604 and Schambers, A., Eavis-O'Quinn, M., Roberge, V., & Tarbouchi, M. (2018). Route planning for electric vehicle efficiency using the Bellman-Ford algorithm on an embedded GPU. 2018 4th International Conference on Optimization and Applications (ICOA), 1-6. doi.org/10.1109/ICOA.2018.8370584. And then studies on shortest path problem with time window constraints became a new hot topic in the 1990s, where the time windows indicates the time period when the node or arc is available for service. See, Di Puglia Pugliese, L., Ferone, D., Festa, P., & Guerriero, F. (2020). Shortest path tour problem with time windows. European Journal of Operational Research, 282(1), 334-344. doi.org/10.1016/j.ejor.2019.08.052. The research on shortest path algorithms with time windows is relevant to first responder vehicle problems considering train crossing blockage. The crossing blockage time periods can consider as time windows that prohibit passage for first responding vehicles. It has been confirmed that most types of shortest path problems belong to either NP-hard (nondeterministic polynomial time) or NP-complete problems. See, Carrabs, F., D'Ambrosio, C., Ferone, D., Festa, P., & Laureana, F. (2020). The constrained forward shortest path tour problem: Mathematical modeling and GRASP approximate solutions. Networks, 78(1), 17-31. doi.org/10.1002/net.22010, Chassein, A., Dokka, T., & Goerigk, M. (2019). Algorithms and uncertainty sets for data-driven robust shortest path problems. European Journal of Operational Research, 274(2), 671-686. doi.org/10.1016/j.ejor.2018.10.006, Ferone, D., Festa, P., & Guerriero, F. (2020). An efficient exact approach for the constrained shortest path tour problem. Optimization Methods and Software, 35(1), 1-20. doi.org/10.1080/10556788.2018.1548015, Saraiva, R. D., & de Andrade, R. C. (2021). Constrained shortest path tour problem: Models, valid inequalities, and Lagrangian heuristics. International Transactions in Operational Research, 28(1), 222-261. doi.org/10.1111/itor.12782, Yu, G., & Yang, J. (1998). On the Robust Shortest Path Problem. Computers & Operations Research, 25(6), 457-468. doi.org/10.1016/S0305-0548(97)00085-3, and Zhen, L., Ma, C., Wang, K., Xiao, L., & Zhang, W. (2020). Multi-depot multi-trip vehicle routing problem with time windows and release dates. Transportation Research Part E: Logistics and Transportation Review, 135, 101866. doi.org/10.1016/j.tre.2020.101866. Due to computational complexity, such problems cannot be easily solved, especially when it comes to a large-scale road network. Table 2 compares the road network scale in the existing literature with that of this project.

Although many studies have been conducted on shortest path problems with time window constraints, there is still limited literature that has investigated the shortest path problems with train blockages. And further, almost no studies have investigated the strategy on how to dispatch first responder vehicles when an emergency occurs, considering train blockages in the road network.

Different from traditional time window constraints existing in the literature, where time window indicates the available service time for specific nodes or arcs, a train blockage window, on the contrary, is the period that needs to avoid being visited. More specifically, when train blockages are taken into consideration, there will be a sequence of nodes being blocked for a particular time period, within which no vehicles will be able to go through the nodes. That time period at each blocked node can be defined as the train “blockage window”. Therefore, in this disclosure, we are going to take the train blockage into consideration, while finding the shortest path for the first responder vehicles. Compared with the traditional shortest path problems with time windows in the existing literature, there are mainly three major challenges and contributions in this project.

This is a multi-origin to single destination shortest path problem, while the traditional problem only needs to find one shortest path between the given Origin-Destination (OD) pair. For each emergency service request, there are several alternative fire stations to choose from.

There is interdependency between crossing blockage time windows, whereas most of existing literature only considered shortest problems with independent time windows. See, Desaulniers, G., Madsen, O. B. G., & Ropke, S. (2014). Chapter 5: The Vehicle Routing Problem with Time Windows. In Vehicle Routing (pp. 119-159). Society for Industrial and Applied Mathematics. doi.org/10.1137/1.9781611973594.ch5, Di Puglia Pugliese, L., Ferone, D., Festa, P., & Guerriero, F. (2020). Shortest path tour problem with time windows. European Journal of Operational Research, 282(1), 334-344. doi.org/10.1016/j.ejor.2019.08.052, El-Sherbeny, N. A. (2014). The Algorithm of the Time-Dependent Shortest Path Problem with Time Windows. Applied Mathematics, 05(17), 2764. doi.org/10.4236/am.2014.517264, Hiermann, G., Puchinger, J., Ropke, S., & Hartl, R. F. (2016). The Electric Fleet Size and Mix Vehicle Routing Problem with Time Windows and Recharging Stations. European Journal of Operational Research, 252(3), 995-1018. doi.org/10.1016/j.ejor.2016.01.038, Sancho, N. G. F. (1994). Shortest Path Problems with Time Windows on Nodes and Arcs. Journal of Mathematical Analysis and Applications, 186(3), 643-648. doi.org/10.1006/jmaa.1994.1324, and Zhen, L., Ma, C., Wang, K., Xiao, L., & Zhang, W. (2020). Multi-depot multi-trip vehicle routing problem with time windows and release dates. Transportation Research Part E: Logistics and Transportation Review, 135, 101866. doi.org/10.1016/j.tre.2020.101866. The interdependency between time windows requires the shortest path search algorithm to dynamically update travel time during the routing.

The road network scale of this project is larger, as seen in the detailed comparisons in Table 2. The large network complicates the computational demand of the algorithm.

Train Information and Estimated Train Arrival Time Calculation

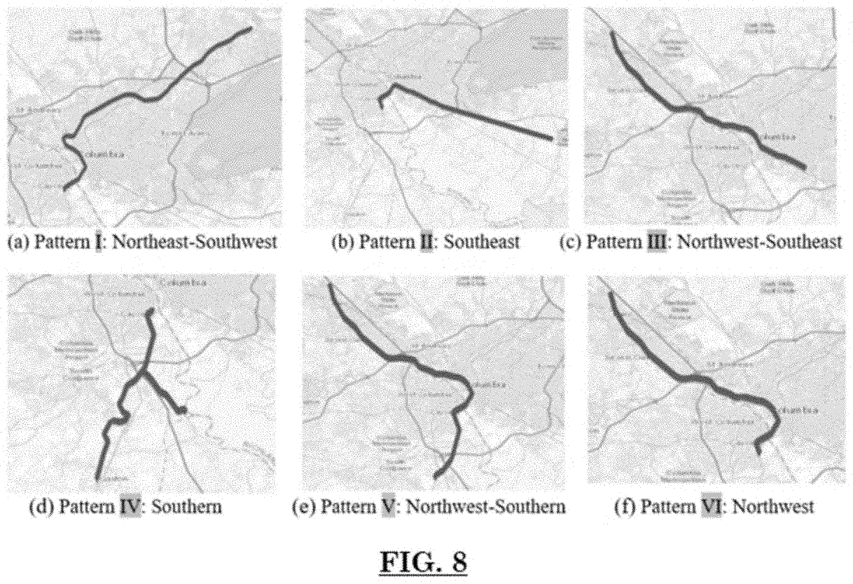

Based on the freight train operation data shared by CSX, dynamic GPS locations are extracted for all the train around the City of Columbia, South Carolina, USA, from Oct. 31, 2020, to Nov. 10, 2020. Six major train routes are identified as shown in FIG. 8.

Totally, we identified 116 unique train IDs amongst 39,773 train GPS records, and the proportions of each pattern in FIG. 8 are (a) 12.1%, (b) 12.9%, (c) 3.4%, (d) 39.7%, (e) 5.2% and (f) 25.9%, respectively. Note specific train ID and its route cannot be released due to security issues.

FIG. 8 sheds light on how the trains will go through the City of Columbia, so that we can predict the train direction for the following minutes. Given current train length, location, and speed information, then we can primarily estimate blocked nodes with corresponding blockage windows.

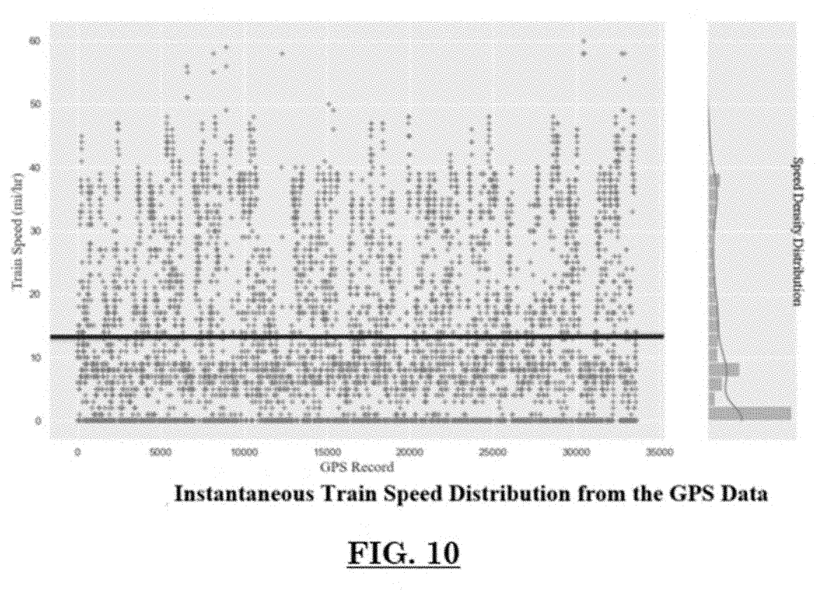

Table 3 summarizes the length distribution of 39,773 GPS recorded trains in feet. From Table 3, we can see that the length of trains ranges from 40 to 17,028 feet. Combined with the information on train operating speed (see FIG. 10), we can briefly infer that the length of train blockage windows might fluctuate from seconds to hours.

FIG. 10 shows the instantaneous velocity distribution of 33,617 trains from the GPS data within 20 km of the City of Columbia center. FIG. 10 illustrates that train speeds vary from 0 to 60 miles per hour, with an average speed of around 13 mi/hr. Also, we should notice that the instantaneous velocity equaling zero takes the highest proportion of the distribution, which indicates that when a train is going through the City of Columbia, it may take several necessary stops, which will also unavoidably contribute to the uncertainty of the train blockage window predictions, especially for the time durations of the blockage windows.

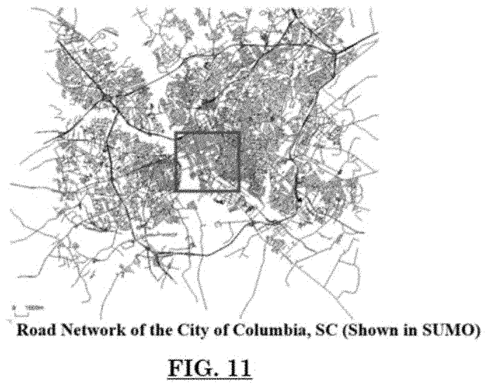

Besides, as for the road network, FIG. 11 presents the road network of the City of Columbia, SC. As shown in Table 2, there are a total of 7,668 nodes together with 21,502 arcs that will be potentially affected by train blockages. If any fire emergency occurs, then fire departments need to make quick decisions on (1) which fire station should dispatch vehicles in response to the emergency, and (2) which path should be the optimal route from the fire station to the destination, regarding the minimum response time, especially to avoid train blockages.

Route Optimization Considering Stochastic Crossing Blockage

The shortest path problem for first responder vehicles with train blockage windows consists in finding a single-origin and single-destination shortest path in a train crossing network for emergency vehicles, which can be described as follows. Given a directed non-negative weighted graph, where is the set of nodes and is the set of weighted arcs. For each grade crossing node, a blockage window will be generated at each node. Variables that will be used in this disclosure are listed in Table 4.

Train Blockage Window Estimate

To estimate train blockage windows, some basic train information is needed, such as train length, current location, and operating speed. Given the train information known above, then we can estimate the start time of the train blockage window at the next grade crossing node v:

$${t}_{v}^{0} = {t}_{0} + \frac{{d}_{t r a i n}^{i , j}}{{v}_{t r a i n}^{t}} \qquad ( 4 )$$

where t₀ stands for the current time.

Then combined with the train length information, we can briefly predict the length of the train blockage window at the crossing node v, i.e., the end of the blockage window:

$${t}_{v}^{1} = {t}_{v}^{0} + \frac{{l}_{t r a i n}}{{v}_{t r a i n}^{t}} \qquad ( 5 )$$

Note that trains may suddenly accelerate, decelerate or completely stop at any time; therefore, the train operating speed in Equations (4) and (5) are not a constant, which should be updated with instantaneous train velocity, or we can also apply the last 5-minute average speed to the equations in case that the recorded instantaneous velocity equals zero, which will result in an infinite length of the train blockage window.

Optimization Model

The shortest path algorithm is mainly based on the Label Correcting Algorithm and will be modified while taking train blockage windows into consideration. The key to the modified algorithm is to update the estimated vehicle arrival time.

$${T}_{j} = \{ \begin{matrix}{t}_{v}^{1} if {t}_{v}^{0} < {T}_{i} + {\overline{t}}_{i j} < {t}_{v}^{1} \\ {T}_{i} + {\overline{t}}_{ij} , Otherwise\end{matrix} , ∀ i , j ∈ V \qquad ( 6 )$$

Equation (6) estimates the updated arrival time of an emergency vehicle at node j. If the initial arrival time, Tᵢ+t̅ᵢⱼ, falls into the train blockage window at the node j, then it will be adjusted to the end of the blockage window.

Then we can calculate the expected time delay at node v. Generally, the expected delay time at node v can be written as:

$${D}_{v} = \{ \begin{matrix}0 , if {T}_{v} < {t}_{v}^{0} or {T}_{v} > {t}_{v}^{1} \\ {t}_{v}^{1} - {T}_{v} , Otherwise\end{matrix} \qquad ( 7 )$$

Then the total time delay can be calculated as:

Dₜₒₜₐₗ=Σ_{v∈V}Dᵥ (8)

Initially, we are going to find the shortest path with minimum response time, then the optimization model can be generated as follows:

$$Z = min {T}_{s} = {min}_{x} {\sum }_{( i , j ) ∈ A} ( {T}_{j} - {T}_{i} ) \cdot {x}_{i j}^{rs} , ∀ r , s ∈ V \qquad ( 9 )$$

$$s . t .$$

$${\sum }_{j} {x}_{i j}^{rs} - {\sum }_{i} {x}_{i j}^{rs} = \{ \begin{matrix}1 , ∀ i = r \\ 0 , ∀ i \neq r , ∀ j = s \\ - 1 , ∀ j = s\end{matrix} \qquad ( 10 )$$

$${x}_{i j}^{rs} = \{ \begin{matrix}1 , if {a}_{ij} lies on the path ( r , s ) \\ 0 , otherwise\end{matrix} , ∀ {a}_{i j} ∈ A , ∀ r , s ∈ V \qquad ( 11 )$$

The objective function (9) minimizes the accumulative response time when the emergency vehicle finally arrives at the destination after the emergency occurs. Equation (10) represents the flow balance constraints for a path between origin node r and destination node s, i.e., any node except the origin and destination should satisfy flow-in equals to flow-out; for the origin node, flow-out equals to one without flow-in; and similarly for the destination node, flow-in equals to one without flow-out. Equation (11) defines the binary decision variable.

Considering that mathematically minimizing the total response time equals minimizing the total delay time in Equation (8), then the original optimization model can be rewritten as:

$$min {D}_{total} = {min}_{x} {\sum }_{( i , j ) ∈ A} {D}_{j} \cdot {x}_{i j}^{rs} , ∀ r , s ∈ V \qquad ( 12 )$$

$$s . t .$$

$${\sum }_{j} {x}_{i j}^{rs} - {\sum }_{i} {x}_{i j}^{rs} = \{ \begin{matrix}1 , ∀ i = r \\ 0 , ∀ i \neq r , ∀ j = s \\ - 1 , ∀ j = s\end{matrix} \qquad ( 13 )$$

$${x}_{i j}^{rs} = \{ \begin{matrix}1 , if {a}_{ij} lies on the path ( r , s ) \\ 0 , otherwise\end{matrix} , ∀ {a}_{i j} ∈ A , ∀ r , s ∈ V \qquad ( 14 )$$

The objective function (12) calculates and then minimizes the total time delay when the emergency vehicle goes through each node on the path. Equation (13) represents the flow balance constraints for a path between origin node r and destination node s. Equation (14) defines the binary decision variable.

Shortest Path with Train Blockage Window Algorithm

The pseudo-code for the modified Label Correcting Algorithm is provided as follows.

Results and Discussion

A case study of the first responder vehicle dispatch problem with train blockage from the City of Columbia, SC, will be presented herein, and various emergency scenarios when receiving emergency calls at different time points will be discussed.

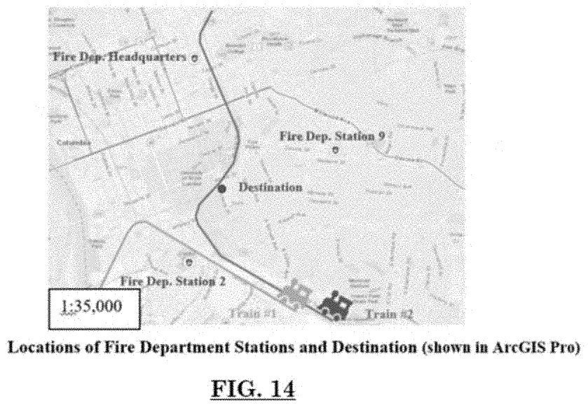

FIG. 14 presents the geographic locations of fire department stations and fire emergency destination, which is near an Italian restaurant, DiPratos. Assume that there are two separate trains departing at time 9 a.m. and 9.09 a.m., respectively. Then, we can estimate the train blockage windows along the train routes from Equations (4) and (5). Table 5 lists the train blockage windows (in minutes after 9 a.m.) at the first ten grade crossing nodes for each train. Table 6 shows the shortest path distance from each fire station to the destination, DiPratos. According to the distance, Table 6 also gives priority to dispatching vehicles from each fire station to the destination.

Given the train blockage window and road network information above, we are going to simulate fire emergencies that happened at DiPratos at different time point scenarios and see how the train blockages will affect the fire station vehicle dispatch strategies.

To make comparisons, baseline dispatch strategy will be introduced, and the response time of the baseline dispatch strategy will also be calculated. The mechanism of the baseline dispatch strategy is that when fire departments dispatch emergency vehicles, decision-makers will not consider train blockages; instead, they will dispatch vehicles directly from the closest fire station and follow the distance-based shortest path to the destination. If any train blockages are reported at grade crossings, a new vehicle will be dispatched from the next closest station (see the “priority” column in Table 6) until one vehicle finally arrives at the destination, or all regional fire stations have dispatched at least one vehicle, but all dispatched vehicles have been blocked at crossings.

According to the NFPA Standard 1710, the “turnout time” can range from 80 seconds to 146 seconds, with regard to different credible intervals, here to simplify and standardize the model, we assume that there will be an additional 120-second time delay added to the total response time as extra “turnout time” when dispatching a new vehicle from another fire department station.

Scenario #1: Fire Emergency Call at 8.50 a.m.

Note the trains will be at different locations and block different crossings along the path if the emergency call is received at a different time. Suppose a fire emergency occurs near Fire destination at 8.50 a.m.

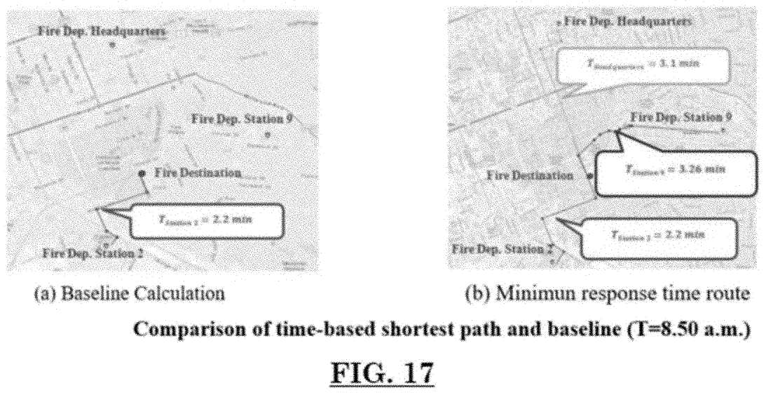

In this scenario, according to FIG. 17 at (a) and (b), the fire department would dispatch vehicles from Fire Department Station 2, and the time-dependent shortest path is the same as the distance-based shortest path, and also the same as the one from the baseline dispatch strategy. This is because when this fire emergency happens, no trains are going through the city, and this is a traditional shortest path problem, i.e., the distance-based shortest path also means being the least time-consuming. Meanwhile, the baseline strategy will also consider the same route to dispatch vehicles directly; therefore, there is no time saved or wasted in this scenario.

Scenario #2: Fire Emergency Call at 9.07 a.m.

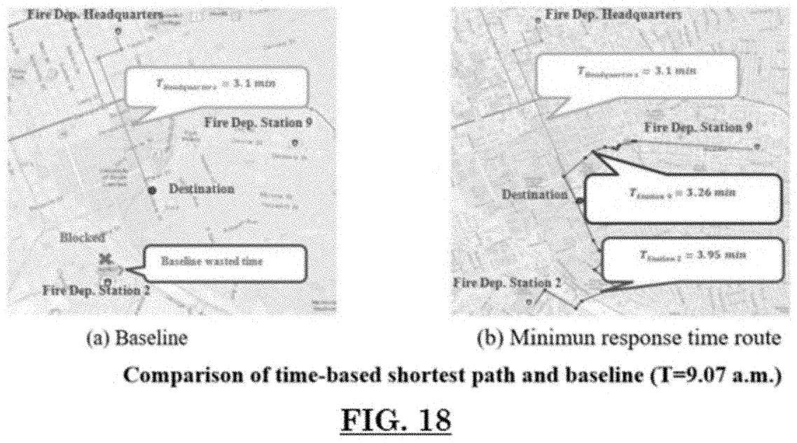

In this scenario, the baseline dispatch strategy will not consider potential blockages at grade crossings and will continue to dispatch vehicles from Station 2 for the first thought with the same distance-based shortest path in FIG. 17 at (a). Unavoidably, vehicles will be blocked when arriving at the fourth crossing node of Train #1 between 9.07 a.m. and 9.08 a.m., which directly falls into the train blockage window, see the blue dash line in FIG. 18 at (a). Alternatively, a new vehicle will then be dispatched, and finally get to the destination, see the solid line in FIG. 18 at (a). However, with the baseline dispatch strategy, the time spent dispatching vehicles from Station 2 has actually been wasted.

By contrast, we can directly see from FIG. 17 at (b) that in this case, Headquarters dispatches vehicles following the green-marked time-dependent shortest path and can expect the vehicle arrives at the destination within 3.1 minutes and it is recommended to dispatch vehicles from Fire Department Headquarters, instead of Station 2 by the algorithm.

Scenario #3: Fire Emergency Call at 9.10 a.m.

In this scenario, a fire emergency occurs near DiPratos at 9.10 a.m.

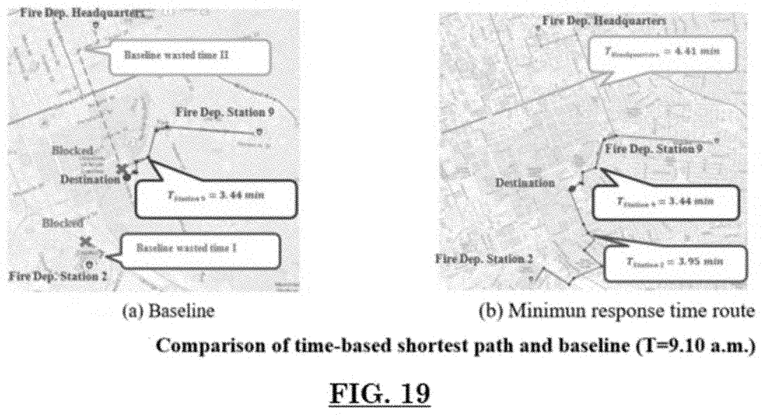

FIG. 19 at (a) demonstrates that in this scenario, distance-based shortest paths from both Fire Department Station 2 and Headquarters will be blocked at train crossing nodes (see the blue and green dash lines in FIG. 19 at (a)). As a result, although Fire Department Station 9 is the geographically furthest fire station to the destination, still it is the optimal station to dispatch vehicles at that time with the recommended route (marked as the solid red line) as shown in FIG. 19 at (a), and our algorithm suggests dispatching vehicles from Fire Department Station 9 with the quickest responding time at 3.44 minutes in FIG. 19 at (b).

Scenario #4: Fire Emergency Call at 9.45 a.m.

In this scenario, a fire emergency near Fire destination is reported at 9.45 a.m., when both trains have left downtown Columbia. Accordingly, the recommended shortest path is the same as reported above. The result is reasonable because before and after train blockages, the problem becomes a traditional shortest path problem. Thus, the time-dependent shortest path becomes the same route as the distance-based shortest path.

The results presented in FIG. 17 at (a) and (b) imply that for the same destination, the time-dependent shortest path is sometimes contradictory to the distance-based shortest path. Specifically, the distance-based shortest paths from other origins being blocked can temporarily make the second or even the third shortest path the most time-efficient route.

Table 7 summarizes the conditions when to dispatch emergency vehicles from each fire station and how to choose the corresponding shortest path in each condition. Based on Table 7, we can also expect to save time while dispatching first responder vehicles compared to the baseline dispatch strategy when considering potential train blockages, which is the essential prerequisite for saving lives, reducing injuries and damages on properties.

Stochastic Units Dispatching Scenarios

Here, we will consider first responder units travelling on the road and employ the time-based shortest path algorithm to dispatch vehicles.

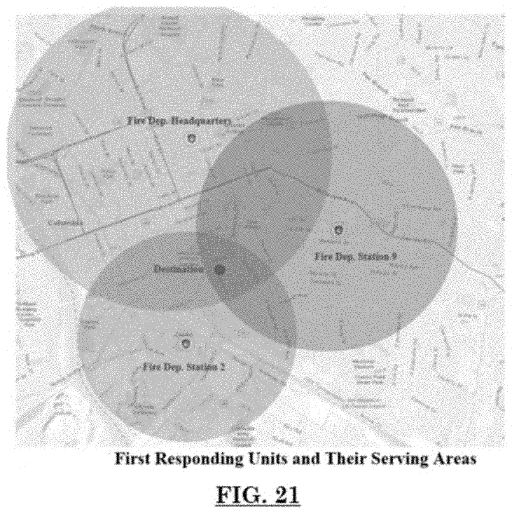

Suppose there three first responding units serving the areas as shown in FIG. 21.

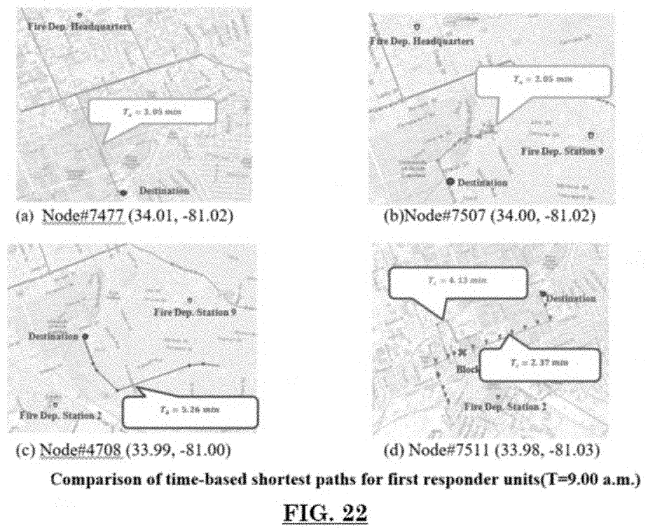

Suppose there is an emergency occurring near DiPratos at 9.00 a.m., the GPS reported coordinates (Longitude, Latitude) of three first responder vehicles are at Node #7477 (34.01, −81.02), Node #7511 (33.99, −81.00) and Node #4708 (33.98, −81.03), see FIG. 22 at (a), (c) and (d) respectively.

For baseline calculation, the first blue vehicle will be dispatched at Node #7511 with the blue dotted route in FIG. 22 at (d), with the minimum expected response time (2.37 min) to arrive at the destination. However, the vehicle will be blocked at one grade crossing (marked red cross in FIG. 22 at (d)), then the second priority dispatching vehicle has moved to Node #7507 (see FIG. 22 at (b)), and it can get to the destination in another 2.05 min, which means the total baseline dispatching time should be 1.28+1(delay)+2.05=4.33 min.

FIG. 22 at (a) also indicates that the algorithm suggested the optimal route in this case with the minimum responding time at 3.05 min, saving 1.28 min (29.6%).

If again, there is an emergency occurring near DiPratos at 9.10 a.m., given the same units locations as shown in FIG. 22 at (a), (c) and (d).

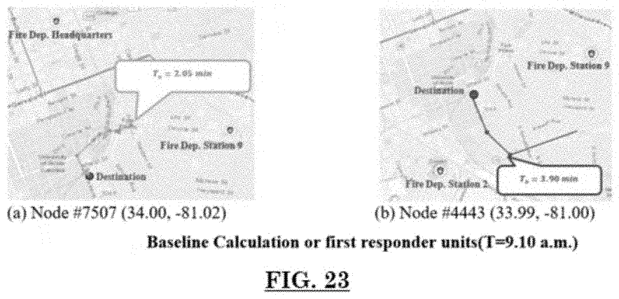

For baseline calculation, the first blue vehicle will also be blocked at the same location as in the previous scenario, when the second green vehicle is dispatched following the route in FIG. 22 at (b), it will also be blocked (see FIG. 23 at (a)), finally, the third purple vehicle (updated from Node #4708 to Node #4443) will be dispatched as shown in FIG. 23 at (b).

Therefore, in this scenario, the total baseline response time equals 1.28+1(delay)+2.05+1(delay)+3.90=9.23 min, while the corresponding travel time of the algorithm recommended route (orange solid line in FIG. 22 at (d)) is 4.13 min, saving 5.10 min (55.3%).

When the first responders are on the way responding to emergencies, every second matters. This project investigates first responder shortest path problems with train blockages by filling the knowledge gap that there is still limited literature that has focused on the train blockage influence on road network while studying the shortest path problems. We proposed an optimization model and developed the corresponding algorithm based on the Label Correcting method. A series of case studies from the City of Columbia, South Carolina has been conducted to verify the effectiveness and robustness of the model. Our results implied that considering train blockages in real-world conditions can help save up to 61.6% for fixed fire stations and 55.3% for stochastic first responding units of the time compared to not considering blockages.

Despite the contributions of this project, there are still a few limitations that should be noted. Firstly, although we proposed a mathematical model to estimate train blockage windows, it is still more than arduous to precisely predict the train blockage windows in real-world conditions. Secondly, we presume other traffic participants will all yield to the emergency vehicles as the first responders have the right of way during emergencies. Therefore, we are not considering any delay due to traffic congestions or traffic lights in this disclosure. Other factors such as weather conditions, left-turns, and height limits are also ignored, but these factors will inevitably requires more response time. Finally, some grade crossing nodes cannot be well matched from the rail and road networks, according to the coordinates provided from the two networks separately. We eliminated such unmatched crossings while conducting case studies.

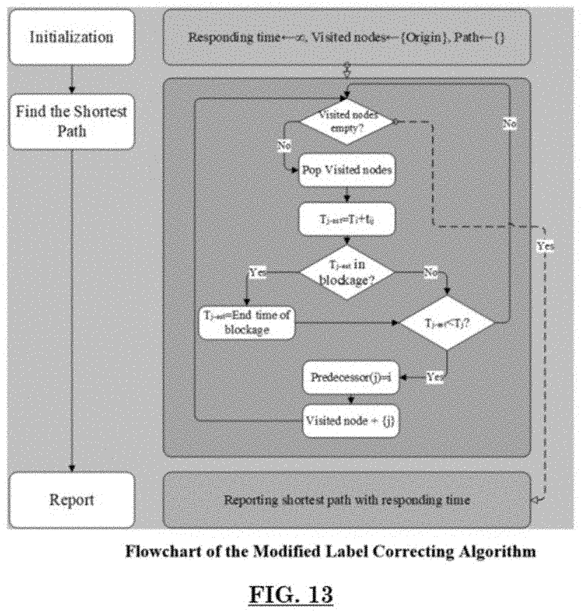

The methods herein involve providing at least one mathematical model to a system to determine an optimized shortest path, such as the correcting algorithm shown in operation at FIG. 13, with respect to a city roadway system integrated with railroads and railroad crossings. In one embodiment, the mathematical model may be modular in nature and operated by a software program comprising microprocessor-executable instructions to specifically configure the system to perform the methods described herein and provided as part of a software module or library. As an example, these models may be pre-stored on the system and added to the system periodically, for example, as part of a distributed update periodically stored on the system. Or may be downloaded from the Internet or another network or other electronic medium as required. Alternatively, the mathematical model may not be part of a software module or library, but rather may be hard coded in a unitary software program or otherwise an integral part thereof. In any case, the model is provided to the system as an input, and is stored in a memory of the system, for example, in a mathematical model data storage.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A first responder shortest path optimization method comprising:
determining a time window at least one location to be avoided by at least one vehicle;
wherein the at least one vehicle can originate at multiple origin points and have only a single destination;
wherein at least one shortest path algorithm is dynamically updated during a time the at least one vehicle is traveling to the single destination to choose a shortest path to the single destination while avoiding the at least one location to be avoided; and
wherein the shortest path optimization model can be generated with the following:
$$min {D}_{total} = {min}_{x} {\sum }_{( i , j ) ∈ A} {D}_{j} \cdot {x}_{i j}^{rs} , ∀ r , s ∈ V \qquad ( 12 )$$
$${\sum }_{j} {x}_{i j}^{rs} - {\sum }_{i} {x}_{i j}^{rs} = \{ \begin{matrix}1 , ∀ i = r \\ 0 , ∀ i \neq r , ∀ j = s \\ - 1 , ∀ j = s\end{matrix} \qquad ( 13 )$$
$${x}_{i j}^{rs} = \{ \begin{matrix}1 , if {a}_{ij} lies on the path ( r , s ) \\ 0 , otherwise\end{matrix} , ∀ {a}_{i j} ∈ A , ∀ r , s ∈ V \qquad ( 14 )$$
wherein
Dₜₒₜₐₗ is total delay time; and
xᵢⱼ^{rs} is a binary decision variable, wherein xᵢⱼ^{rs}=1 if the link aᵢⱼ lies on the path (r, s), otherwise, xᵢⱼ^{rs}=0.

2. The method of claim 1, wherein the at least one vehicle is a first responder vehicle comprising an ambulance, firetruck, law enforcement vehicle, paramedic, and/or emergency medical technician and/or combinations of the above.

3. The method of claim 1, further comprising wherein the at least one location to be avoided is a railroad crossing.

4. The method of claim 1, further comprising extracting GPS locations for the at least one location to be avoided.

5. The method of claim 1, wherein the method designates each destination to be avoided as a node and paths to the single destination as arcs.

6. The method of claim 1, further comprising wherein the at least one location to avoided is a railroad crossing wherein a train is passing and the algorithm accounts for at least train length, current location, and operating speed with respect to the at least one locations to be avoided.

7. The method of claim 1, wherein objective function equation 12 calculates and the minimizes total delay time, equation 13 represents flow balance constraints for a path from an origin point to a destination point, and equation 14 defines a binary decision variable.

8. The method of claim 7, wherein the origin point is a fire station selected from amongst a group of fire stations with a firetruck dispatched from the fire station that is determined as meeting the shortest path optimization model to the destination.

9. A train blockage time window prediction method comprising:
an algorithm to calculate an expected delay time at a particular railroad crossing comprising:
$${D}_{v} = \{ \begin{matrix}0 , if {T}_{v} < {t}_{v}^{0} or {T}_{v} > {t}_{v}^{1} \\ {t}_{v}^{1} - {T}_{v} , Otherwise\end{matrix} \qquad ( 7 )$$
With the expected delay time calculated as:
Dₜₒₜₐₗ=Σ_{v∈V}Dᵥ (8)
Wherein Dᵥ is expected time delay at the particular railroad crossing;
Dₜₒₜₐₗ is total delay time;
Tᵥ is accumulative time after an emergency occurs when an emergency vehicle arrives at the particular railroad crossing; and
[tᵥ⁰, tᵥ¹] is a train blockage window at point v starting at t=tᵥ⁰ and ending at t=tᵥ¹.
